(19) United States
(12) Patent Application Publication
(10) Pub. No.: US 2021/0206100 A1
(43) Pub. Date: Jul. 8, 2021

(54) THREE DIMENSIONAL (3D) PRINTERS

(71) Applicant: HEWLETT-PACKARD DEVELOPMENT COMPANY, L.P., Spring, TX (US)

(72) Inventor: Samuel SCOFIELD, Vancouver, WA (US)

(73) Assignee: HEWLETT-PACKARD DEVELOPMENT COMPANY, L.P., Houston, TX (US)

(21) Appl. No.: 16/075,621

(22) PCT Filed: Apr. 25, 2017
(86) PCT No.: PCT/US2017/029284

§ 371 Date: Aug. 4, 2018

(51) Int. Cl. B29C 64/357; B33Y 30/00; B33Y 40/00; B29C 64/329; B29C 64/205

(52) U.S. Cl. CPC B29C 64/357; B33Y 30/00; B29C 64/205; B29C 64/329; B33Y 40/00

(57) ABSTRACT

It is disclosed a 3D printing system comprising a carriage and a carriage for 3D printing systems comprising: at least one tool to act on build material over a spreading platform wherein the carriage is movable over the spreading platform along a travel direction; and a deflector that extends from the tool and/or the carriage in at least the travel direction as to prevent build material from moving upwards.

### BACKGROUND

Additive manufacture systems, commonly known as three-dimensional (3D) printers, enable objects to be generated on a layer-by-layer basis. Powder-based 3D printing systems, for example, form successive layers of a build material in a printer and selectively solidify portions of the build material to form layers of the object or objects being generated.

Part of the 3D printing system comprises tools for handling and processing build material in different stages of the printing process such as, for example, conveyors for conveying build material from a storage zone to a spreading surface, spreaders spread a dosed amount of build material over a spreading surface, nozzles to release agents on the build material, etc.

In one example, the spreading surface may be an intermediate surface wherein build material is laid, for example, for its dosing or any other processing before build material is selectively solidified. In a further example, the spreading surface may be a build platform on which build material is selectively solidified.

### BRIEF DESCRIPTION OF THE DRAWINGS

FIG. 1A shows an isometric view of a 3D printing system according to one example.

FIG. 1B is a plan view of the 3D printing system of FIG. 1A.

FIG. 2 shows a sequence for dosing and spreading of build material according to one example.

FIG. 3 shows an example of blocking mechanism attached to a hopper according to one example.

### DETAILED DESCRIPTION

In an example, build material may be a particulate material such as a powder. Mechanical operations on the build material, such as, spreading or conveying, may force build material in directions other than onto the spreading surface, for example such operations may force build material upwards from the spreading surface.

Tools may be attached to a carriage that moves over the build material along a travel direction. The movement of the carriage and the tools may contribute to the generation of airflows that may also force the material upwards or, at least, with an upwards component and, in some cases, maintaining it suspended for some time. Both, suspended and upwardly travelling build material may have negative effects on the electronic components of the tools and/or the carriage and other elements of a 3D printing system.

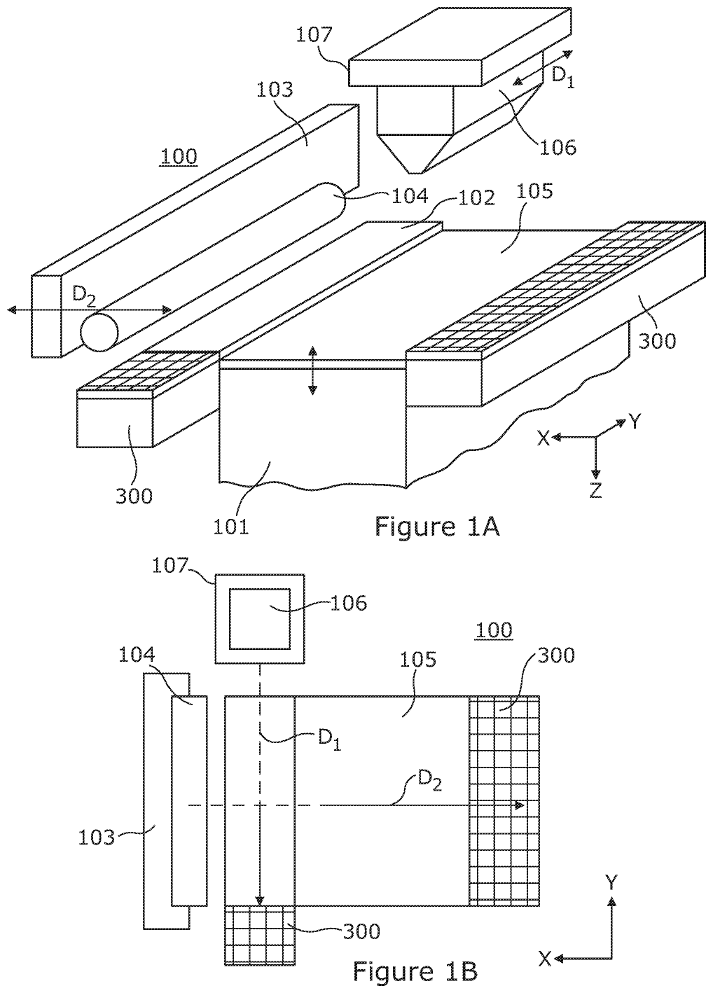

The 3D printing system 100 of FIGS. 1A and 1B comprises a hopper 106 attached to a first carriage 107 that moves in a travel direction. In the example of FIGS. 1A and 1B, the first carriage 107 moves along the Y axis. As the carriage moves along its travel axis, the hopper delivers a pile of build material 200 over the dosing surface 102.

Furthermore, the 3D printing system 100 comprises a build platform 105 wherein a determined amount of build material is to be spread to generate a layer of build material, either directly over the build platform 105 or over a previously formed and processed layer of build material. The build material is spread by means of the spreader 104 which is shown in the figures as a roller but can be any device capable of conveying powdered material such as, e.g., a wiper. This spreader is attached to a second carriage 103 that moves along its travel axis, in the case of FIGS. 1A and 1B, the travel direction for the second carriage 103 is along the X axis, i.e., perpendicular to the axis of the first carriage 107.

Both operations described above, namely: the delivery of build material to a spreading surface (the dosing surface 102) by means of the hopper; and the spreading of build material over spreading surface (the build platform 105) by means of the spreader, are operations that have a physical interaction with the build material and may cause it to become airborne and generate the unwanted effects of build material becoming suspended in the air within the print environment. This may cause a dirty environment wherein, for example, laser or optical systems may not work properly and, also, may cause malfunctioning or damage to electronic components.

As to the functioning of the 3D printing system, the build platform 105 may be part of a build unit 106 that forms a build chamber such build unit 106 may be removable from the 3D printing system or be a fixed module within the system. The 3D printing system 100 forms 3D objects within the build chamber as it selectively solidifies portions of each formed layer of build material. After each layer of build material is selectively solidified the build platform 105 is lowered, along the Z axis, to enable a new layer of build material to be formed thereon. Depending on the particular 3D printing system 100 used, each layer of build material 200 formed may have a height in the region of about 50 to 120 microns.

The 3D printing system 100 may also comprise several build material collection zones 300 wherein excess build material may be collected, for example, for subsequent reuse or storage. In the example of FIGS. 1A and 1B two recycling zones 300 are envisaged at the end of the travel directions of each of the carriages, however, other configurations are also envisaged, for example, a recycling zone may be located around the spreading surfaces, i.e., the dosing surface 102, the build platform 105 and any other surface that is to be in contact with build material. These recycling zones may also comprise, or be connected to, a pump to generate a negative pressure or vacuum as to draw in build material in the vicinity to such recycling zones 300.

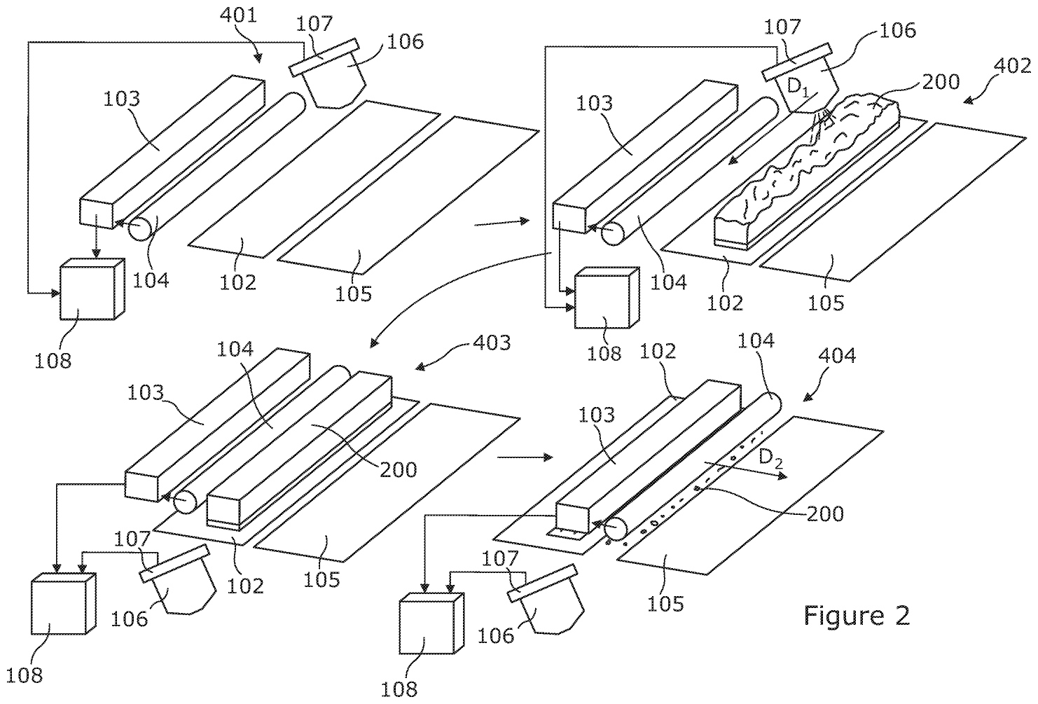

FIG. 2 shows an example of tools that may be used in a 3D printing system. In particular, shown in an initial position 401 there is a first carriage 107 comprising a tool, namely, a hopper 106 and a second carriage 103 comprising a tool, namely, a spreader 104. Both carriages are located initially outside a working area and both of them are configured to act on build material 200 over a spreading surface, in particular, the dosing surface 102 for the hopper 106 and the build platform 105 for the spreader 104. In this particular example, the working area is defined as the area above the spreading surface, i.e., the build platform 105 and/or the dosing surface 102.

In a dosing process 402 a controller 108 controls the movement of the first carriage 107 with the hopper 106 along a first travel direction D₁ and the releasing of build material 200 over the dosing surface 102 in order to generate a pile of build material 200 that may be transferred, at least partially, to a build platform 105 to create a 3D object.

Once the controller 108 has controlled the performance of the dosing process 402, a dosed amount of build material 200 is formed over the dosing surface 12 and the controller 108 may move the hopper 106 to a parking position 403, e.g., a position outside the working area or away from the build material 200. It should be noted that, in the example of FIG. 2, the parking position is opposite to the initial position. In other examples the parking position can also be the initial position.

A similar type of action that can be performed on build material 200 is, for example, using the spreader to spread the build material 404 over a build platform 105. This is performed by using the controller 108 to control movement of a spreader for physically contacting and moving the build material in a second travel direction D₂, from the dosing surface 102 towards a build platform 105. This spreading can be performed by any suitable type of spreader 104, such as a roller, a wiper. In one example, the controller 108 may control the spreader 104 to spread substantially all of the build material 200 from a spreading surface over the build platform 105. In another example, the controller 108 may control the spreader 104 to move a part of the build material 200.

Both types of actions mentioned above, namely, the dosing process 402 and the spreading of build material 404, comprise a physical interaction between tools attached to a moving carriage and the build material 200. As mentioned above, this physical interaction may cause build material to move in a direction other than the spreading surface and, for example, become airborne, as in the case the build material 200 moves with a vertical component.

Furthermore, the movement of the carriage may generate airflows that may cause build material to remain suspended in the air for a determined period of time after each of the passes.

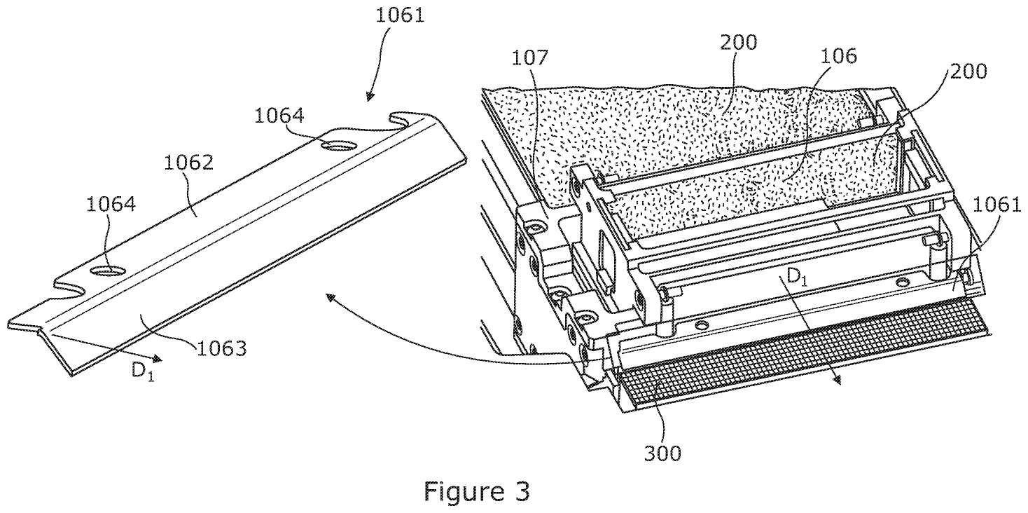

In order to prevent build material becoming airborne in the printing system and, particularly, in the zone over the spreading surfaces, an example hopper is provided that incorporates a deflector on one of its sides that helps prevent build material from moving upwards. Such a hopper is illustrated in FIG. 3 and, also, a similar type of deflector can be attached to other types of tools and/or carriages.

FIG. 3 shows an example of a hopper 106 attached to a carriage 107 adapted to move along a first travel direction D1 as to spread build material 200 along a spreading surface, in this case, a dosing surface 200. FIG. 3 shows the spreader 106 after it has formed a layer of build material 200 over the dosing surface 102.

The carriage of FIG. 3 comprises a blocking mechanism, in this case, a deflector 1061 that extends from the carriage (and also from the hopper 106) along, at least, one of the senses of the travel direction D₁. Alternatively, the carriage or the tool may comprise a deflector on both sides of the travel direction.

The deflector 1061 comprises an attachment 1064 to a carriage 107 and/or a tool (in this case, a hopper 106) located in a straight surface 1062 for the attachment of the deflector to the carriage 107 and/or the hopper 106 and an angled surface 1063 which extends outwards from the carriage 107. build material 200 from moving upwards and forces it to move either downwards or in a direction towards a recycling zone 300. In essence the deflector comprises on its proximal zone the attachment 1064 and on its distal zone the redirection mechanism which may comprise an angled surface.

The angled surface 1063 may be a surface at an angle θ between 0 and 60 degrees below the horizontal, for example, around 45 degrees below the horizontal as to achieve a maximum displacement in the travel direction of upwardly travelling build material 200. This aspect is relevant because a recycling zone 300 may be located in the travel direction of the carriage further from the spreading surface, so it would be beneficial to guide build material towards such a recycling zone 300.

Alternatively, the deflector 1061 may lack an angled surface and be substantially horizontal. In this example, the deflector 1061 may have an attachment to the carriage and/or the tool and a section extending outwardly from the carriage and/or the tool in the travel direction, or parallel to the lower surface of the carriage and/or the tool, therefore, upon contacting upwardly travelling build material, the deflector 1061 will help prevent such material from continuing an upwards movement and forcing most of such upwardly travelling build material down towards the spreading surface. Also, the deflector 1061 may guide suspended build material towards a recycling zone.

In an example, the deflector 1061 may have a specific profile, for example, a metallic profile as to provide mechanical strength to the system. Also, alternatively, the deflector 1061 may extend from the carriage in directions other than the travel direction, such as, a direction perpendicular to the travel direction thereby directing build material in a direction towards the sides of the dosing surface 102.

Once build material 200 is guided towards the recycling zones, such build material 200 may enter a recycling path wherein the build material is, for example, returned to the storage zone wherein it can be mixed with fresh build material for its reuse or be transferred to an intermediate storage unit wherein used build material is stored for further processing, such as cooling.

In essence, it is disclosed a 3D printing system comprising:

a storage zone adapted to receive build material and a spreading platform on which a layer of build material may be formed; and

a carriage comprising tools to act on the build material over the spreading platform wherein the carriage is movable over the spreading platform along a travel direction the carriage comprising a deflector extending from at least one side of the tool and/or the carriage on the travel direction as to restrain the movement of build material with a vertical component.

In an example, the redirection mechanism is an angled surface, for example, angled between 0 and 60 degrees below the horizontal and, optionally, around 45 degrees.

Furthermore, the system may comprise a recycling zone wherein the redirection mechanism guides build material towards the recycling zone. Such recycling zone may also comprise a vacuum generator.

Regarding the tools, a carriage may comprise one or more of the following examples tools: nozzles, print heads, spreaders, conveyors, heaters or lasers. In an example, the tools are tools for spreading the build material over the spreading platform such as, e.g., rollers or wipers. These tools are normally attached to a carriage and the system may comprise more than one carriage wherein at least one of the carriages comprises a deflector.

In a further example, the deflector is substantially flat and extends parallel to the travel direction. The deflector may be attached to the carriage or the tool on its proximal zone and comprises a build material redirection mechanism on its distal zone.

Furthermore, the deflector may be made of metal.

In an example, build material is particulate material, i.e., a powder.

On the other hand, it is disclosed a carriage for 3D printing systems comprising:

at least one tool to act on build material over a spreading platform wherein the carriage is movable over the spreading platform along a travel direction; and

a deflector that extends from the tool and/or the carriage in at least the travel direction as to prevent build material from moving upwards.

In an example, the tool is a hopper to spread build material over the spreading surface. Nonetheless, other types of tools may also comprise a deflector or the carriage itself can comprise it.

Furthermore, the deflector may comprise a redirection mechanism to guide build material moving upwards or suspended build material towards a recycling zone. This mechanism can be, e.g., an angled surface.

1. A 3D printing system comprising:
a storage zone adapted to receive build material and a spreading platform on which a layer of build material may be formed; and
a carriage comprising tools to act on the build material over the spreading platform wherein the carriage is movable over the spreading platform along a travel direction the carriage comprising a deflector extending from at least one side of the tool and/or the carriage on the travel direction as to restrain the movement of build material with a vertical component.

2. A system, according to claim 1, wherein the redirection mechanism is an angled surface.

3. A system, according to claim 2 wherein the angled surface is angles between 0 and 60 degrees below the horizontal.

4. A system according to claim 2 further comprising a recycling zone wherein the redirection mechanism guides build material towards the recycling zone.

5. A system, according to claim 4 wherein the recycling zone comprises a vacuum generator.

6. A system, according to claim 1, wherein the tools are one or more of: nozzles, print heads, spreaders, conveyors, heaters or lasers.

7. A system, according to claim 1 wherein the tools are tools for spreading the build material over the spreading platform.

8. A system, according to claim 1, wherein the deflector is substantially flat and extends parallel to the travel direction.

9. A system, according to claim 1, wherein the deflector is attached to the carriage or the tool on its proximal zone and comprises a build material redirection mechanism on its distal zone.

10. A system, according to claim 1 wherein the deflector is made of metal.

11. A system, according to claim 1 wherein the build material is particulate material.

12. A system, according to claim 1 wherein the system comprises at least two carriages.

13. A carriage for 3D printing systems comprising:
at least one tool to act on build material over a spreading platform wherein the carriage is movable over the spreading platform along a travel direction; and
a deflector that extends from the tool and/or the carriage in at least the travel direction as to prevent build material from moving upwards.

14. A carriage, according to claim 13 wherein the tool is a hopper to spread build material over the spreading surface.

15. A carriage, according to claim 13, wherein the deflector comprises a redirection mechanism to guide suspended build material towards a recycling zone.
